(19) United States
(12) Patent Application Publication
(10) Pub. No.: US 2002/0178100 A1
(43) Pub. Date: Nov. 28, 2002

(54) Asset performance management

(76) Inventor: Paula Koveos, North Sydney (AU)

Correspondence Address: SIDLEY AUSTIN BROWN & WOOD LLP, 875 Third Avenue, New York, NY, 10022, US

(21) Appl. No.: 10/118,443

(22) Filed: Apr. 8, 2002

(30) Foreign Application Priority Data
Apr. 6, 2001 (AU) PR 4260

(51) Int. Cl. G06F 17/60

(52) U.S. Cl. 705/36

(57) ABSTRACT

The invention relates to an asset performance management system to link asset suppliers, asset users and an asset manager. The system includes a data store to store asset related information in accounts held by respective asset suppliers and users. The system also includes an Interface maintained by the asset manager to provide and central access to the database by asset suppliers and users, for them to enter, modify and view asset related data in permitted accounts, and to enable communications between the asset suppliers and users. The system further includes a reporting function operated by the asset manager to monitor asset performance and provide asset performance assessments for assets in the accounts to the respective account holders. In a further aspect, the invention relates to a method of providing asset performance management to suppliers and users of assets.

### BACKGROUND OF THE INVENTION

1. Field of the Invention

This invention relates to asset performance management and, more particularly to a system of, and method for, asset performance management.

2. Description of the Prior Art

Traditionally providers of asset management systems have catered to the needs of the client, the asset user. As a result, asset management systems have consisted of software programs which have been installed and placed on the client's premises with access to records available only to the client's staff, the users. There have been a number of finance companies that have gone the next step and offered asset management to their leasing clients. In this scenario, the software is installed on the client's premises and the financier takes responsibility in updating asset information. Attempts at web enabling such a system, have merely allowed the user access to the software via the web to limited information regarding the assets.

### SUMMARY OF THE INVENTION

Broadly, according to a first aspect,' the invention provides an asset performance management system to link asset suppliers, asset users and an asset manager, the system comprising:

a data store to store asset related information in accounts held by respective asset suppliers and users;

an interface maintained by the asset manager to provide and control access to the database by asset suppliers and users, for them to enter, modify and view asset related data in permitted accounts and to enable communications between the asset suppliers and users;

a reporting function operated by the asset manager to monitor asset performance and provide asset performance assessments for assets in the accounts to the respective account holders.

The assessment may include a history of the assets performance, and a measure of the performance related to a benchmark for that asset. The assessments may be displayed as graphical reports. The assessments may enable the asset user to measure the effectiveness of assets deployed and to provide feedback to the asset supplier.

A further feature of the invention is that all contracts pertaining to an asset, such as the Lease Contract or the Service Contract may be scanned and stored against the asset record. This allows the asset supplier and user to view the exact document which was originally signed off.

The asset supplier may be a dealer of office equipment r any other commercially utilised equipment. Information subscribed by the asset suppliers may include technical specifications pertaining to the particular assets, for example office equipment.

The asset user may de a client of multiple asset suppliers, who leases equipment from these asset suppliers.

The data store may be a computer database or repository—The interface may be an Internet website which is in communication with the data store. An advantage of implementing the system on the Internet is that asset suppliers and users can communicate through the Interface without the need for enabling software. The system interfaces with clients' and suppliers' systems. A further advantage of the invention is that asset suppliers and users can view or modify remotely, 24 hours a day by simply accessing the system via a web browser.

The interface may enable the asset user to log a service call to a service agent provided by the asset supplier in response to equipment failure. Furthermore the interface means may enable the asset user to check the status of previously logged calls whilst also enabling the asset supplier to inform the asset user when a logged call has been actioned or remedied.

The Invention may further Include a ‘QuikFix’ facility consisting of information supplied by asset suppliers to enable asset users to quickly receive solutions in response to asset failures.

Each asset may have a unique identification code stored as information in the data store. Furthermore, information stored in the data store may include the asset's geographical location. A floor plan of a users' premises may additionally be linked to the data store. The location of each asset may be stored as coordinates on the associated floor plan.

Monitoring of the assets' performance may include the real time tracking of the asset's location. T4 facilitate tracking of an asset, an asset reader may be attached to each asset. The asset reader may transmit within the radio frequency spectrum and may transmit the unique identification code together with the coordinates of the assets location. The transmitted unique code and assets location may be detected by the asset performance management system and the assets location updated in the data store.

An advantage of such s facility is that it alleviates the need for users to manually update the data store each time an assets is moved. A further advantage is that the facility is capable of tracking the physical location and movement of assets throughout an organisation. Furthermore, when the floor plan of a users premises where assets are located is associated with the date store, a user Is able to search the floor plan and view the various assets located on that floor. As the data exists in real time, the floor plan image will also indicate movement between points an a, floor.

The asset reader may define parameters outlining at which coordinates on the floor plan an asset is authorised to be located. The asset may further include an alarm which may be automatically activated should the asset be removed from the within an authorised location. The alarm may be in the form of an email, sms message, or the like. The system may therefore be used as an asset security system.

Broadly, according to a second aspect the invention provides asset performance management to suppliers and users of assets, comprising the steps of:

storing asset related information in accounts held toy respective asset suppliers and users; storing asset related information in accounts held toy respective asset suppliers and users;

maintaining an interface to provide and control access to the database by asset suppliers and users, for them to enter, modify and view asset related data in permitted accounts, and to enable communications between the asset suppliers and users;

monitoring the performance of assets in the accounts and providing asset performance assessments for assets in the accounts to the respective account holders.

### BRIEF DESCRIPTION OF THE DRAWINGS

Examples of the invention will now be described with reference to the accompanying drawings, in which:

FIG. 1 is a flow chart of the asset performance management system;

FIG. 2 is a homepage of a website of an asset manager providing a service in accordance with the invention;

FIG. 3 is a window that is displayed on activating a button from the homepage;

FIG. 4 is a window that is displayed can activating a button from FIG. 3:

FIG. 5 is a window that is displayed on activating a button from FIG. 4;

FIG. 6 is a window that is displayed on activating a button from FIG. 5;

FIG. 7 is a window that Is displayed on activating a button from FIG. 6;

FIG. 8 is a window that is displayed on activating a button from FIG. 7;

FIG. 9 is a window that is displayed on activating a button from FIG. 8;

FIG. 10 is a window that is displayed on activating a button from the homepage;

FIG. 11 Is a window that is displayed on activating a button from FIG. 10;

FIG. 12 is a window that is displayed on activating a button from FIG. 1;

FIG. 13 is a window that is displayed on activating a button from FIG. 11 or FIG. 12;

FIG. 14 is a window that is displayed on activating a button from FIG. 4 or FIG. 10;

FIG. 15 is a window that Is displayed on activating a button from FIG. 14;

FIG. 16 is a window that is displayed on activating a button from FIG. 15;

FIG. 17 is a window that is displayed on activating a button from FIG. 16;

FIG. 18 is a window that is displayed on activating a button from the homepage;

FIG. 19 is a window that is displayed on activating a button from FIG. 18;

FIG. 20 is a window that is displayed on activating a button from FIG. 19;

FIG. 21 is a window that is displayed ors activating a button from the homepage;

FIG. 22 is a window that is displayed on activating a button from FIG. 21; and

FIG. 23 is a window that is displayed on activating a button from FIG. 2.

### DETAILED DESCRIPTION OF THE PREFERRED EMBODIMENT

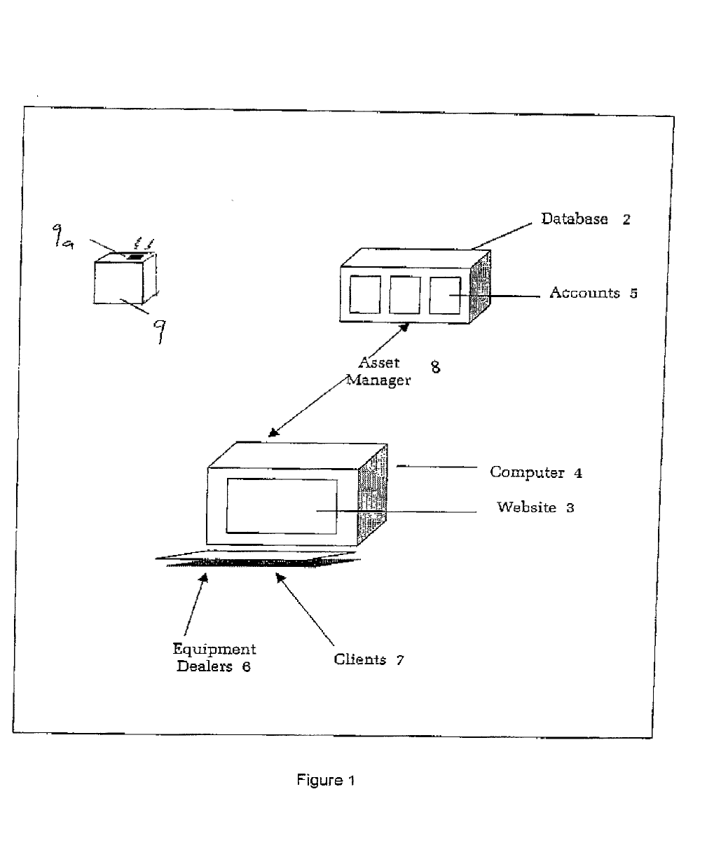

FIG. 1 shows an asset performance management system 1 with a data store In the form of an updateable database 2, an interface to the database 2 In the form of website 3, the website 3 accessible via a computer 4. The database 2 stores information in accounts 5 held by asset suppliers and asset users who in this example are office equipment dealers 6 and their clients 7 who procure office equipment respectively. An asset manager 6 allows for the creation of accounts 5. and maintains the website 3 through which the office equipment dealers 6 and their clients 7 access their accounts 5. Individual pieces of office equipment 9 have radio frequency asset readers 9a attached. The asset reader 9a transmits within: the radio frequency spectrum a unique identification code together with the coordinates of the assets location. The transmitted unique code and assets location are detected by the asset performance management system and stored in the database 2.

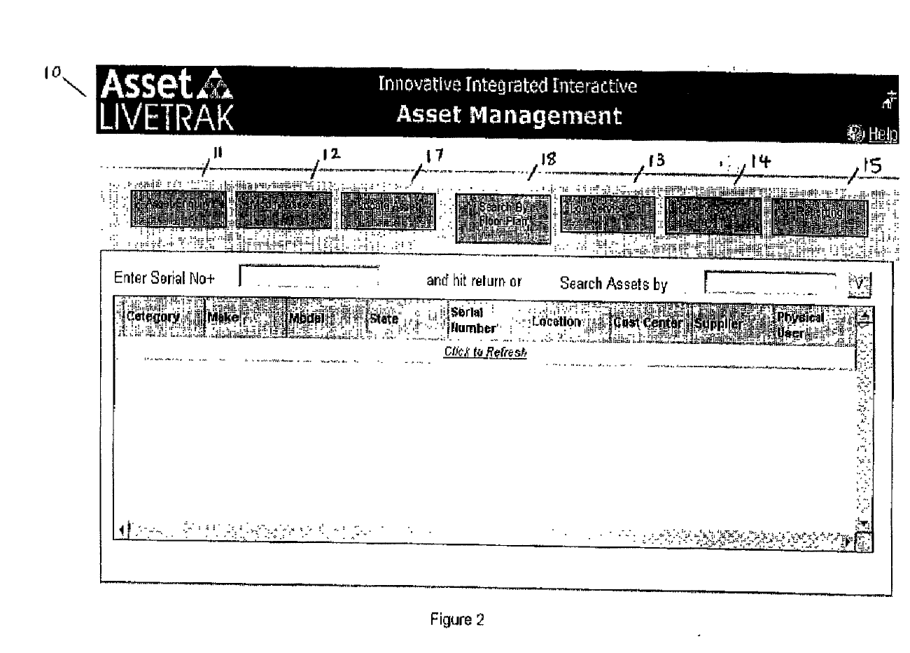

Window 10 of FIG. 2 shows the main console of the web enabled asset management system. An equipment dealer or a client of theirs, having logged on to the web-site of the asset manager is connected to the main console 10. The main console is where the equipment dealers and their clients, or people authorised by the dealers and clients, can navigate to different parts of the system. The user, who may be an equipment dealer or a client can “Modify an Asset” by clicking button 12, generate a report by clinking the “Reporting” button 15 or lodge an “Asset Inquiry” by clicking button 11. Furthermore a client may wish to “Log a Service Call” 13 in relation to a particular piece of equipment which the client is currently leasing. An equipment dealer may wish to “Check Service Calls” 14 previously logged by a client of theirs.

A client may need to determine where within their promises a particular piece of equipment is housed—The client can do so by clicking the “locate” button 17. Alternatively, a client may want to “search the floor plan '!8 of their premises in order to audit the different types of equipment present on that floor. Such options are available for equipment equipped with radio frequency asset readers.

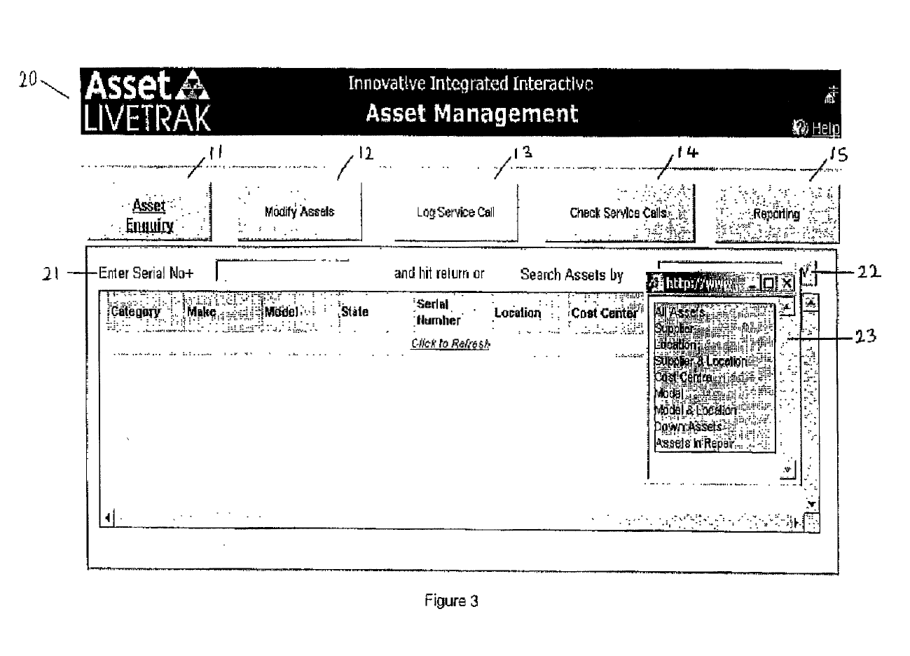

By clicking on “Asset Inquiry” 11, the user is connected to window 20, FIG. 3. A serial number or asset identification number (Id#) associated with a particular asset can be entered into field 21_if the asset identification number is not known, button 22 is activated which opens a subsidiary window 23, and allows for the asset to be searched according to different headings. A client for example may search according to a supplier name and/or that supplier's location; alternatively they may want to list all the assets available. An equipment dealer may search, for example, according to the assets that are currently being repaired, the equipment model arid/or the location of the 10 equipment.

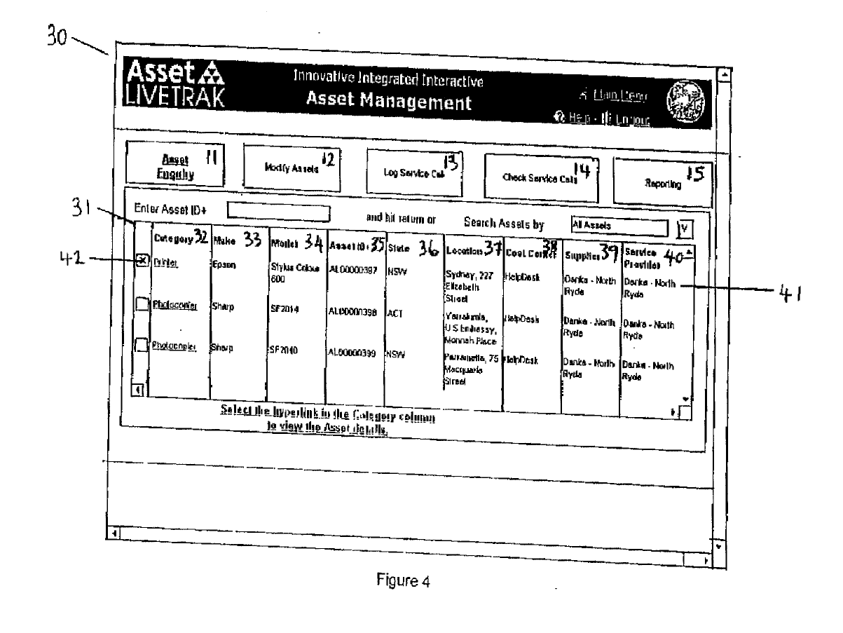

Window 30 of FIG. 4 shows the result of searching according to “All Assets”. A spreadsheet 31 lists Information in columns according to “Category” 32, “Make” 33, “Model” 34, “Asset ID#” 35, “State” 36, “Location” 37, “Cost Centre” 38, “Supplier” 39 and “Service Provider” 40. For example, line 41 i5 indicates that an Epson Stylus Colour 600 Printer with an Asset ID# of AL00000397 is currently leased to the occupier at 227 Elizabeth Street in the State of NSW. The supplier and service provider for the printer is Danka and all cost centre inquiries are to be directed to the help desk. By clicking on the hyperlink field 42 the user can view a full description of the asset.

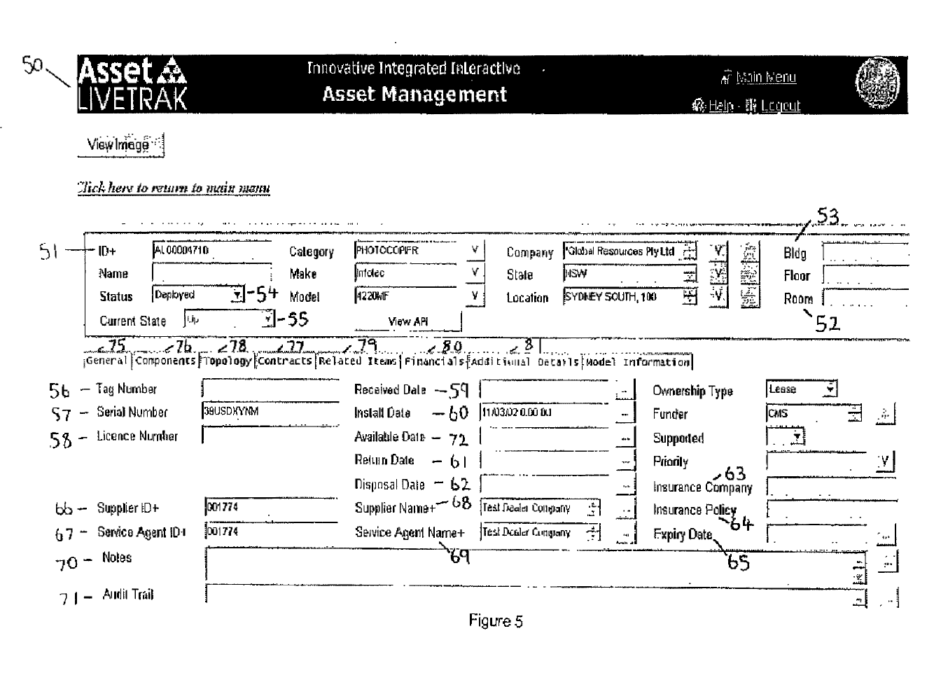

Window 50 of FIG. 5 provides a full description of an Infotec 4220MF Photocopier currently leased to Global Resources Pty Ltd of Sydney South, 100 NSW Australia. This information is contained in box 51 in the top portion of window 50. Further information may indicate the “Room” 52 and “Building” 53 which the equipment is housed to make the process of locating and remedying 25 the problem more efficient. Additionally, the “Status” 54 and “Current State” 55 of the photocopier may be furnished. Further Information is included in the lower portion of window 50 and Includes the photocopiers ‘Tag Number” 56, “Serial Number” 57, “Licence Number” 58, the date with which the order for the photocopier was placed 59 and the date when the photocopier was installed 60, the date with which it is due to be returned 61 or disposed of 62, the clients “Insurance Company” 63, “Insurance Policy” number 64 and “Expiry Date” 65, the asset “Suppliers la#” 66 and the “Service Agents IDW” 67, the asset “Suppliers Name” 68 and the “Service Agents” Name 59. Furthermore, “Notes” may be added 70 and an “Audit Trail” established 71. If the equipment is off 35 hire, there may be information entered into its availability 72.

Clicking the “General” button 75 provides identification information, dates pertaining to the asset, notarising the supplier and the service agent. Clicking the “Components” button 76 provides a list of additional components attached to the asset, The “Contracts” button 77 lists all contracts pertaining to the asset 5 with any available corresponding document. The “Topology” button 78 lists all Items attached to this asset in the network: Upstream, Downstream and peer to peer. The “Related Items” button 79 lists all Help desk calls related td the asset. “Financial” information is detailed under button 80. Additional or miscellaneous items such as the recording of meter readings model specifications and images are located by clicking on the “Additional Details” button 81.

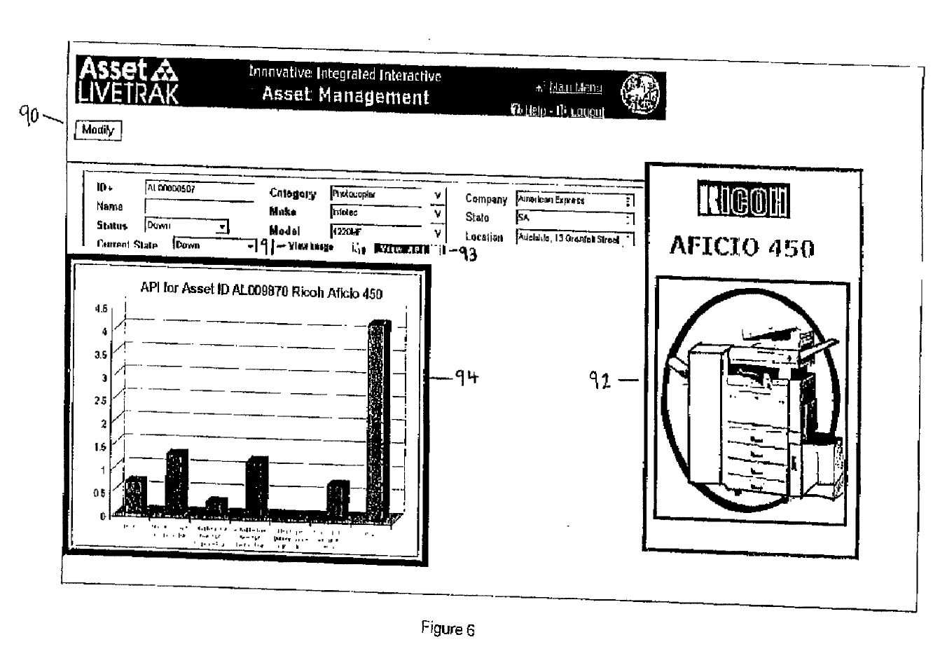

When clicking Button 81, the user is connected to Window 90, FIG. 6. Users can dick on the “View Image” button 81 to view the graphical representation 92 of the asset Model. By clicking on the “View API” button 93, the asset users can view the asset performance indiostor 94 for that month for the particular asset they are querying. The API consists of a weighted average of asset performance indicators such as asset down-time and response times. The API is graphically available to show the overall API of various assets and assist in decisions regarding scrapping or upgrading or retaining of equipment.

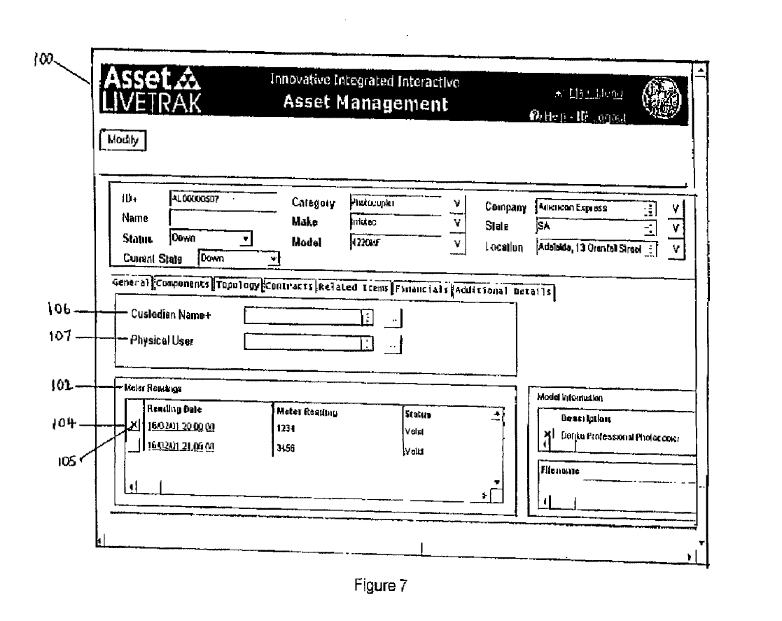

Clicking the “Related Items” button 79 of FIG. 5, opens window 100 of FIG. 7. Within window 100 meter readings are listed 102 for items that require meter readings, such as photocopiers and printers. For example, line 104 informs the user that the meter was read on 18/02/01 at 207:00:00, the meter recorded 1 234 and its status was valid. Additionally, activating button 105 connects to window 50 of FIG. 5. Also contained within window 100 are fields 106 and 107 for information entry associated with “Custodian Name” and “Physical U sera' respectively.

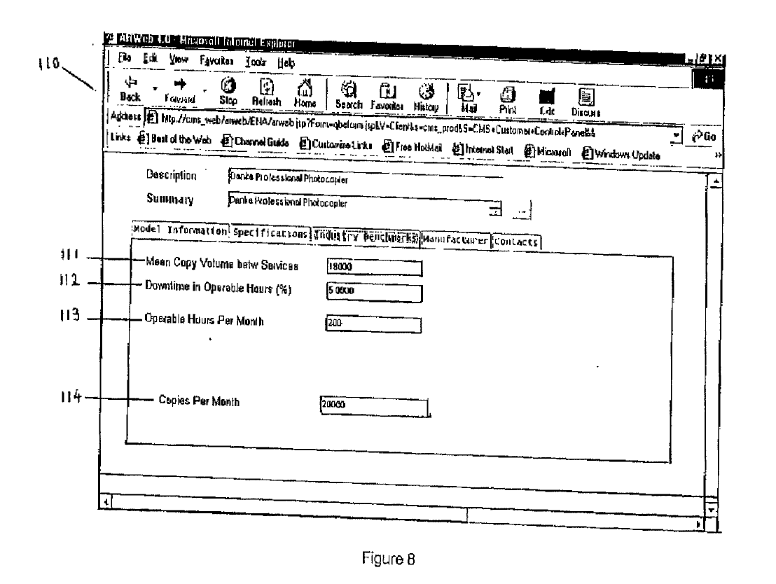

Window 110 of FIG. 8 displays the “Industry Benchmarks” for the Danka Professional Photocopier. The benchmarks for this type of equipment include the “Mean Copy Volume between Services” 111, the “Downtime in Operable Hours” (as a %) 112, the “Operable Hours per Month” 113, and the “Mean Copies per Month” 114. This information is later used in the reporting section to visually measure asset performance against the industry benchmarks.

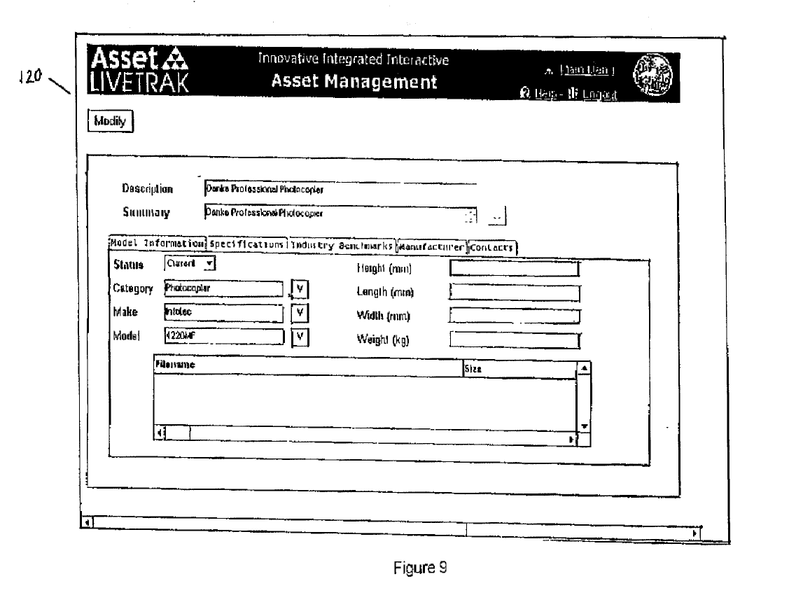

Window 120 of FIG. 9 provides the full asset specifications for the equipment that includes information such as “Height”, “Length”, “Weight”, “Category Name”, “Make” and “Model”.

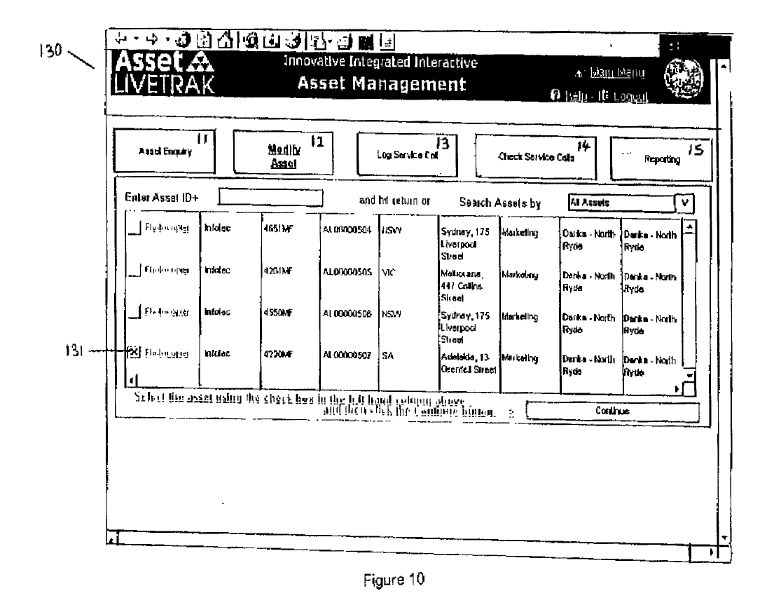

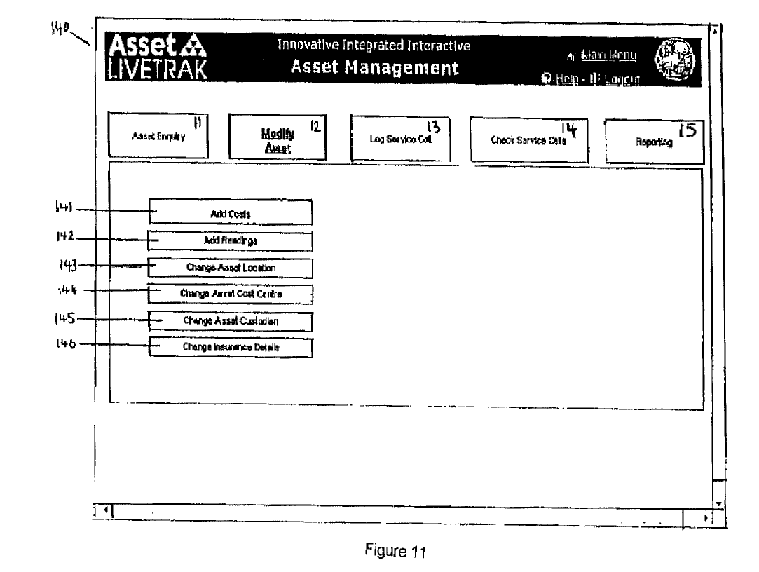

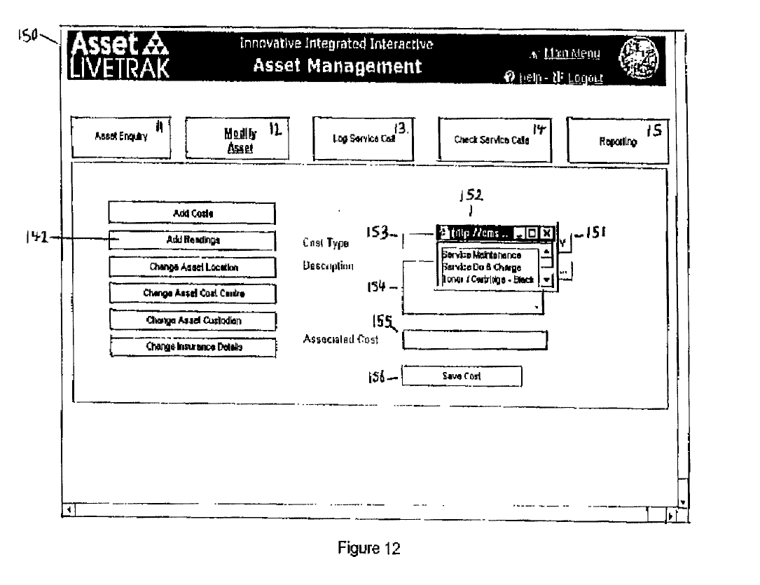

From the main console window 10 of FIG. 2 users can activate button 12 to modify an asset. Window 130 of FIG. 10 displays a spreadsheet of all assets leased by a particular client. The user, if wanting to change the details of the Infotech 4220MF Photocopier activates button 131. The user is presented with a subsequent window 140 of FIG. 11 and is provided with a series of options. The user may “Add Costs” 141, “Add Readings” 142, “Change the Asset location” 143, “Change the Asset Cost Centre” 144, “Change the Asset Custodian” 145 or “Change the Insurance Details” 146 of the asset. To add costs, the user activates button 141 which subsequently opens window 150 of FIG. 12. To select a cost type, for example “service maintenance” or “toner cartridge replacement”, the user activates button 151, which opens up a subsidiary window 152, The user can then select an appropriate cast type, which is automatically entered into field 153. The user may then input further details into the “Description” field 154 and any “Associated Costs” into field 155. Clicking button 156 saves all data entered.

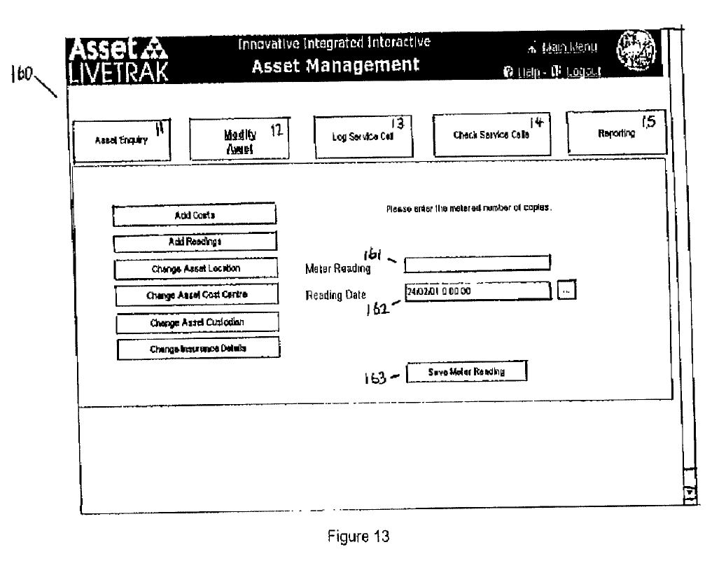

To “Add Readings” the equipment dealer activates button 142 from 20 window 150, FIG. 12 or window 14(x. FIG. 11, Activating button 142 opens window 160 of FIG. 13. The equipment dealer enters the meter reading into field 151 and the date of the reading into field 1162. Clicking button 153 saves the data. A similar convention in order to change and add details exists for all the other categories 141-146 in the “Modify Asset” section.

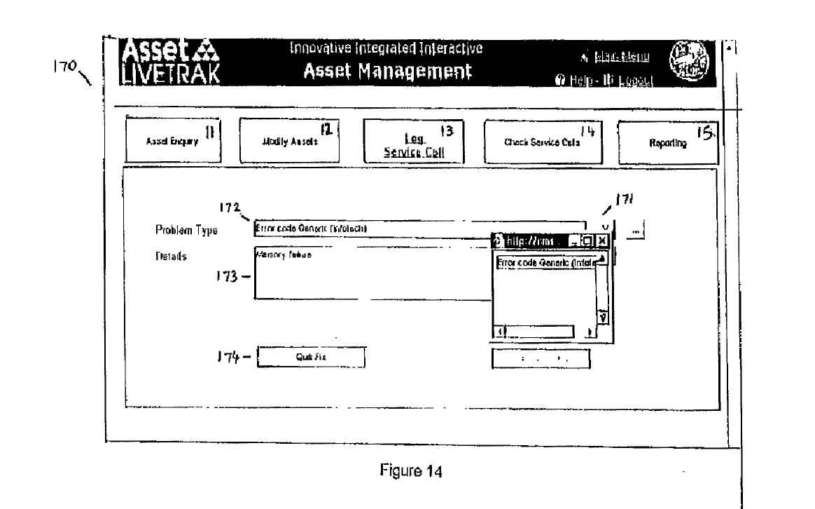

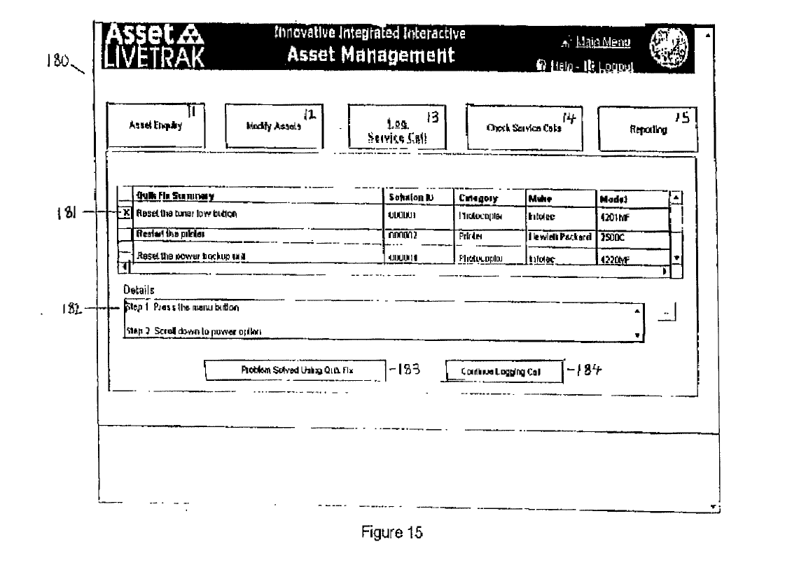

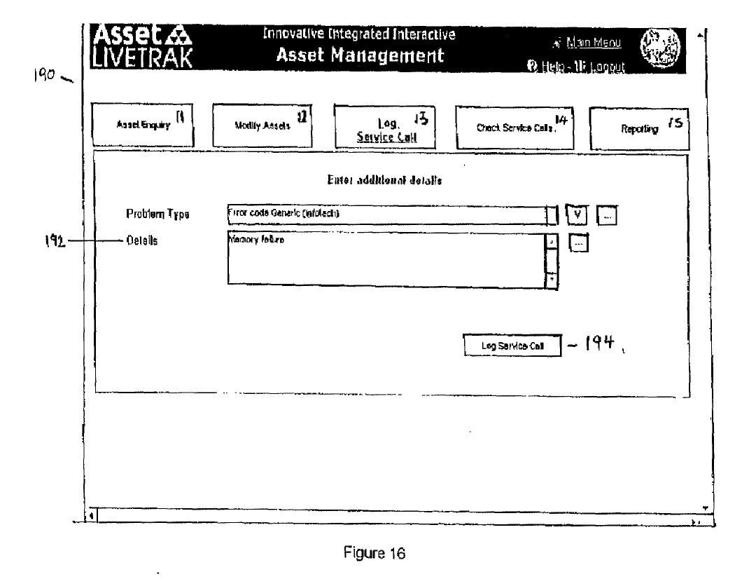

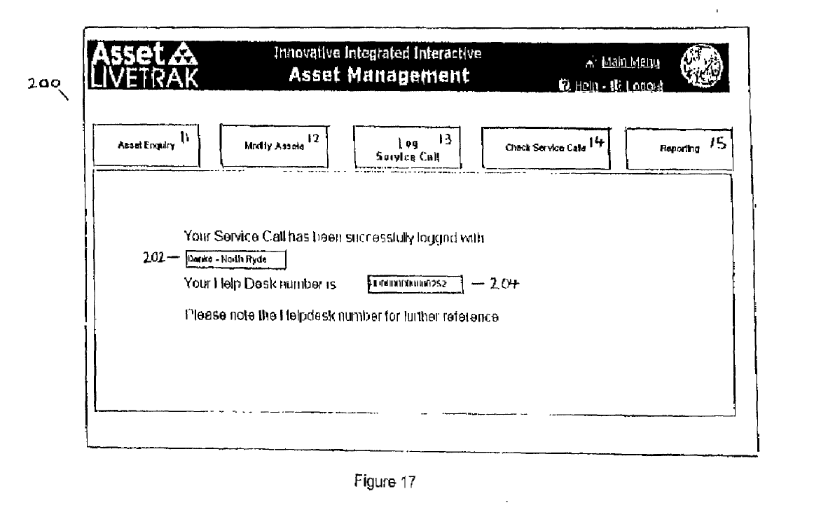

Alternately, from window 30 of FIG. 4 or window 130 of FIG. 10, the user can log a service call after having selected the asset to which the service call relates. The call is logged by activating button 13, which opens window 170 of FIG. 14. The user is required to classify the problem by its type. For known models, preloaded error codes are displayed by activating button 171. If the error code is present it is selected and automatically appears in the field “Problem Type” 172. Alternately, data may be directly entered into field 172. Additional “Details” may be entered into field 173. If the “QuikFix” button 174 is displayed then this means that a ready solution is available. All known service faults for an equipment model are pre-loaded into the system, along with known solutions. This provides instant resolution therefore minimizing the need for a service call to be lagged. The user will click this button which opens window 98D of FIG. 15. in the “QuikFix” section, a resolution of the problem 181 and a step by step guide 182 is provided. The user has the choice to state whether the problem was solved using the QuikFix method by activating button 183 or to “Continue Logging the Gall” by activating button 154. If the user chooses to continue to log the call lay clicking on button 184, window 190 of FIG. 16 opens so that the user can add additional details regarding the problem into fold box 192 and then proceed to click on the “Log Service Call Button” 194. Once the call has been logged, a message appears window 210 of FIG. 17. The message notifies the user of the Help Desk Reference Number 204 for to future correspondence and the Service Agent 202 with which the call has been logged. The service agent Is notified by either e-mail, fax or tele-messaging and can act on the call, as well as provide resolution through the Help Desk.

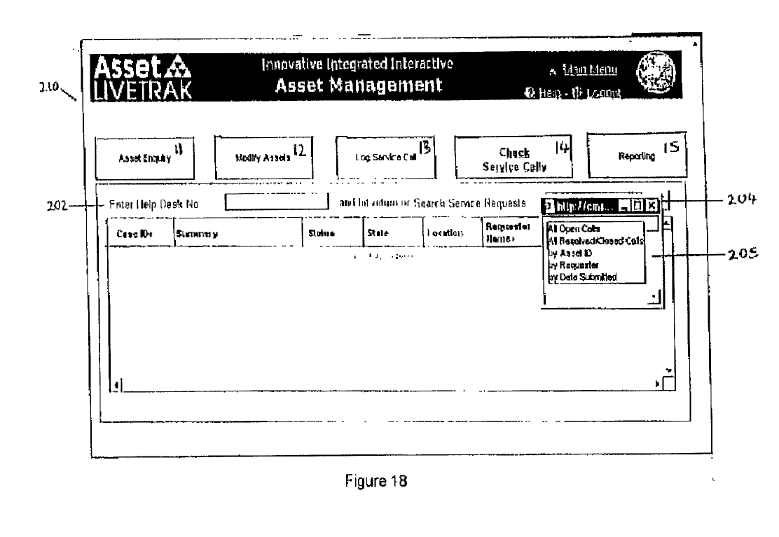

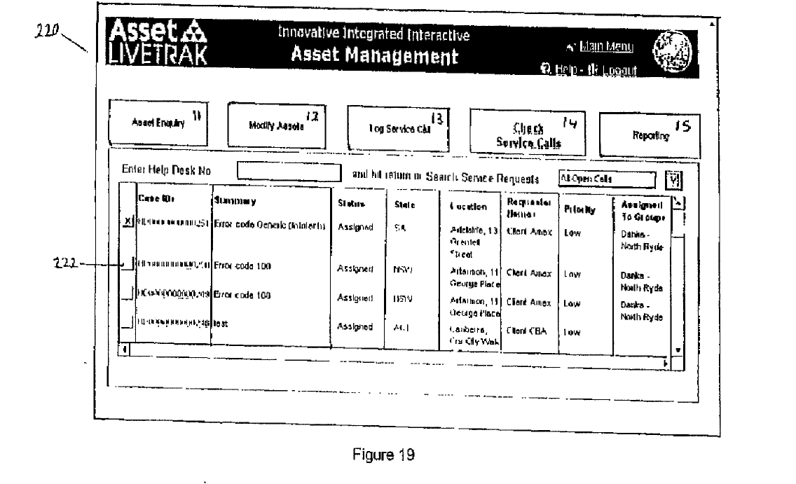

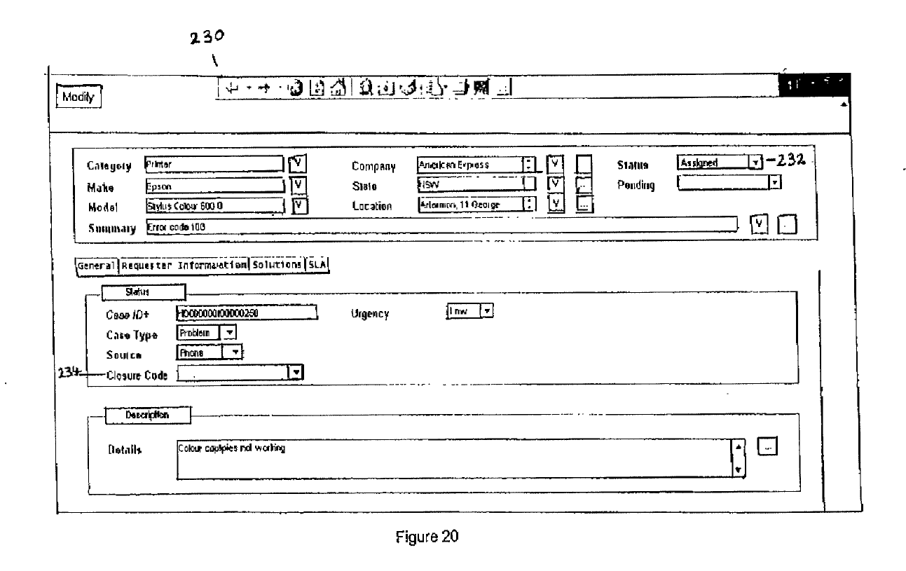

From the Main Console window 10 of FIG. 2, or from within numerous other windows, a user can click on the “Check Service Calls” section by activating button 14. Window 210 of FIG. 18 opens. If the client knows the “Help Desk Reference Number” they will enter this number into field 202. If they cannot recall it, they can search for service calls by clicking button 204, which pulls up a subsidiary window 205. They can search for calls by fields such as: “All Open Calls”, “All Resolved or Closed calls”, By the “Asset ID#”, by the “Requestor”, or by the “Date Submitted”. If the user chooses, “All Open Calls” a summary window 220 of FIG. 19 appears. The user selects the help desk query that they need to look at by clicking button 222, and the user is linked to window 230 of FIG. 20. The “Status” 232 of the call can be viewed and an equipment dealer can close a problem by entering data into the 25 “Closure Code” 234.

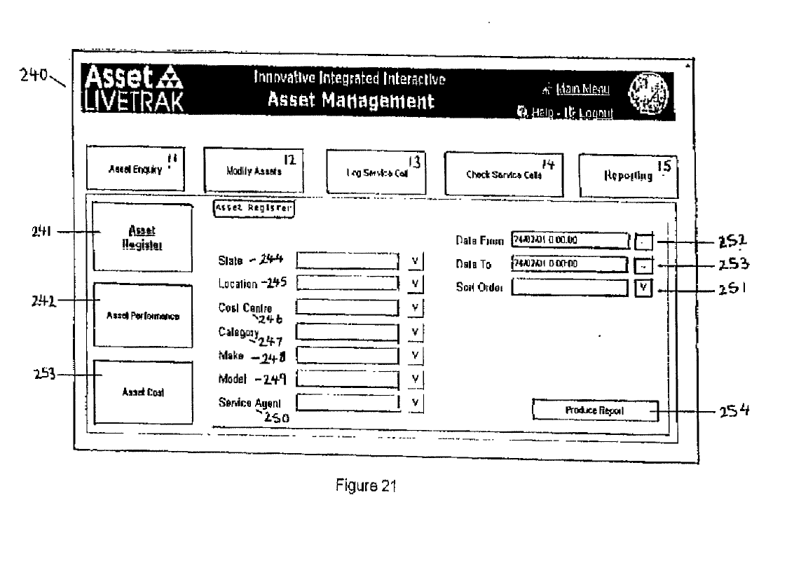

Window 240 of FIG. 21 is accessible from licking the “Reporting” button 15 from the Main console. Information viewable in FIG. 8 is incorporated into a reporting function which is maintained, by the account manager who, generates reports which are available to the user. A variety of reports including “Asset Register” 241, “Asset Performance” 242 and “Asset Cost” 243 are available for each asset. Upon choosing the type of report, user can select a variable and period over which to produce the report. For example, the user can choose If they would like to report on a particular “State” 244 or “Location” 24,5, a particular “Cost Centre” 246, “Category” 24?, “Make” 248, “Model” 249, or “Service Agent” 250. Additionally, the user can click the “Sort Order” button 251 so as to sort the dates by any one of these variables.

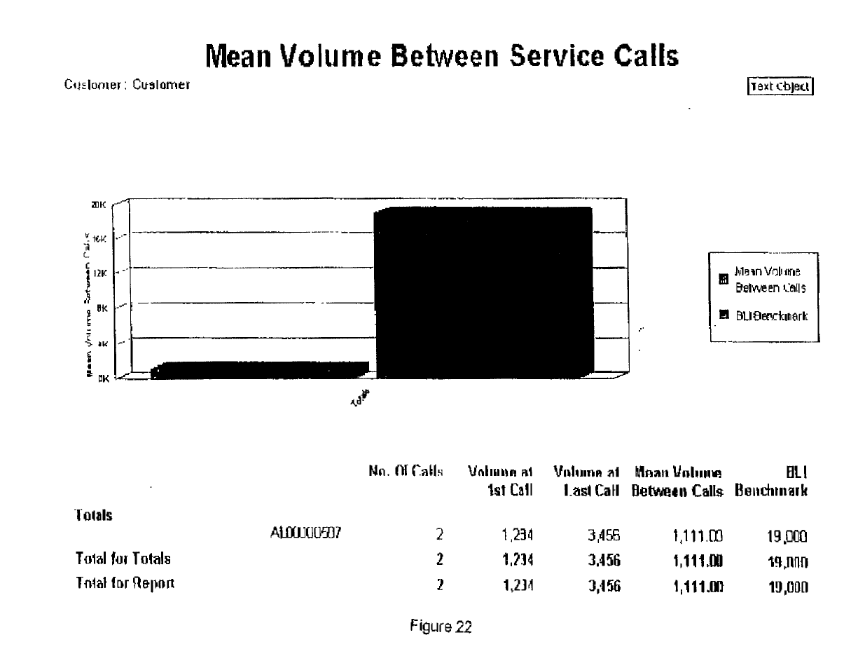

The “Date From” ,252 and “Date To” 253 buttons provide the period with which to produce the report. The user then activates the “Produce Report” button 254 an example of which is shown in FIG. 22. Other reports include “Asset Downtime Reports”, “Help Desk Query Reports”, “Service Response Time Reports”, “Service Level Agreement Monitoring”, “Reporting against Industry Benchmarks” and “Product Specific Reports”.

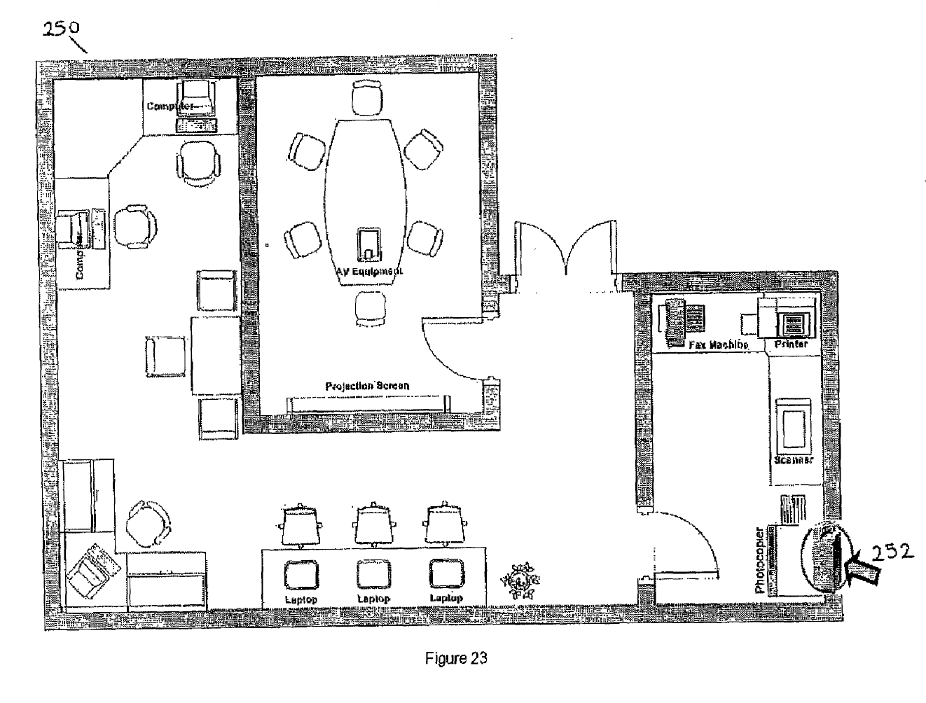

Window 250 of FIG. 23 is accessible from clicking the “Locate Asset” button 17 from the Main console window (FIG. 2)_The user, wanting to locate the Infotec 422UMF Photocopier with serial number 39tJSD>fYNM, clicks button 17. The user Is then prompted to enter known information pertaining to the asset such as its serial number or model—Once the asset has been identified, FIG. 23 opens which shows the floor plan of the premises of Global Resources Pty Ltd. The asset 252, which the user wants to locate, is identified as being in the bottom corner of the eastern wing. The user can obtain full details of the asset 252 by double clicking on the icon, Doubling clicking will take the user back to a window format as shown in FIG. 5.

Alternatively, FIG. 23 may be opened by clicking the ‘Search by Floor Plan’ button 18 from the main console. The user having clicked button 18 is presented with a scroll down subsidiary window. The user may click the 'show all assets' field in relation to a particular location. Each item that is currently leased within the selected location will be shown. Similarly, double clicking on any of the assets shown will take the user to a window format as shown in FIG. 5. Such a facility is advantageous far asset auditing and asset security.

A further embodiment of the invention include Wireless Application Protocol (WAP) enabling the website so those users can have direct access via a WAP enabled mobile phone.

The system is not restricted to office equipment dealers and their clients. An asset supplier who providers a service to a client may lease, hire or contract equipment or labor to meet the needs of industries including telecommunications, financial, medical, entertainment and hospitality. The clients may be large multinational or international business facilities and institutions that require leasing of industry specific equipment for multiple premises over periods of several years. Alternatively the clients may be small local based companies who only require the asset suppliers services for shorter time periods over weeks or possibly months.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. An asset performance management system to link asset suppliers, asset users and an asset manager, the system comprising:
a data store to store asset related information in aunts held by respective asset suppliers and users;
an interface maintained by the asset manager to provide and control access to the database by asset suppliers and users, for them to enter, modify and view asset related data in permitted accounts, and to enable communications between the asset suppliers and users;
a reporting function operated by the asset manager to monitor asset performance and provide asset performance assessments for assets In the accounts to the respective account holders.

2. An asset performance management system according to claim 1 where the asset performance assessment enables the asset user to measure the effectiveness of the deployed asset arid to provide feedback to the asset supplier.

3. An asset performance management system according to claim 2, where the asset performance assessment includes a history of the asset's performance and a measure of the asset's performance related to a benchmark for that asset.

4. An asset performance management system according to claim 1, where the asset performance assessment is displayed as a graphical report.

5. An asset performance management system according to claim 1, where the asset user is a client of multiple asset suppliers, who leases equipment from these asset suppliers.

6. An asset performance management system according to claim 1, where the asset supplier is a dealer of office equipment.

7. An asset performance management system according to claim 1, where the system interfaces with clients' and suppliers' systems.

8. An asset performance management system according to claim 1, where the interface enables the asset user to log a service call to a service agent provided by the asset supplier in response to equipment failure.

9. An asset performance management system according to claim 8, where the interface means further enables the asset user to check the status of previously logged calls whilst also enabling the asset supplier to inform the asset user when a logged call has bean actioned or remedied.

10. An asset performance management system according to claim 1, further comprising a ‘QuikFix’ facility which includes information supplied by asset suppliers to enable asset users to quickly receive solutions in response to asset failures.

11. An asset performance management system according to claim 1, where information subscribed by the asset suppliers Includes technical specifications pertaining to the particular asset.

12. An asset performance management system according to claim 1, where the interface is an Internet website which is in communication with the data store.

13. An asset performance management system according to claim 1, where the data store is a computer database or repository.

14. An asset performance management system according to claim 1, further comprising contracts pertaining to an asset scanned and stared with the asset information in the data store.

15. An asset performance management system according to claim 1, where monitoring of the asset performance includes real time tracking of the asset.

16. An asset performance management system according to claim 15, where an asset reader is attached to the asset to transmit data.

17. An asset performance management system according to claim 16, where information stored in the data store further includes the asset's geographical location, and the data transmitted by the asset reader includes the coordinates of the assets' location and a unique Identification code.

18. An asset performance management system according to claim 17, where the transmitted data pertaining to the asset's geographical location is automatically updated in the data store.

19. An asset performance management system according to claim 18, where a floor plan of an asset users' premises is linked to the data store to continually monitor the location of the asset.

20. A method of providing asset performance management to suppliers and users of assets, comprising tile steps of:
storing asset related information in accounts held by respective asset suppliers and users;
maintaining an interface to provide and control access to the database by asset suppliers and users, for them to enter, modify and view asset related data in permitted accounts, and to enable communications between the: asset suppliers and users;
monitoring the performance of assets in the accounts and providing asset performance assessments far assets in the accounts to the respective account holders.

21. A method of providing asset performance management according to claim 20, where the performance assessment enables the asset user to measure the effectiveness of the deployed asset and to provide feedback to the asset supplier.

22. A method of providing asset performance management according to claim 21, where the performance assessment includes a history of the asset's performance and a measure of the asset's performance related to a benchmark for that asset.

23. A method of providing asset performance management according to claim 20, where the asset performance assessment is displayed as a graphical report.

24. A method of providing asset performance management according to claim 20, where the asset user is a client of multiple asset suppliers, who leases equipment from these asset suppliers.

25. A method of providing asset performance management according to claim 20, where the asset supplier is a dealer of office equipment.

26. A method of providing asset performance management according to claim 20, where the system interfaces with clients' and suppliers' systems.

27. A method of providing asset performance management according to claim 20, where the interface enables the asset user to log a service call to a service agent provided by the asset supplier in response to equipment failure.

28. A method of providing asset performance management according to 30 claim 20, wherein the interface means further enables the asset user to check the status of previously logged calls whilst also enabling then asset supplier to inform the asset user when a logged call has been actioned or remedied.

29. A method of providing asset performance management according to claim 20, further comprising the step of troubleshooting, whereby information supplied by asset suppliers is reviewable by asset users to enable asset users to quickly receive solutions in response to asset failures.

30. A method of providing asset performance management according to claim 20, where information subscribed by the asset suppliers includes technical specifications pertaining to the particular asset.

31. A method of providing asset performance management according to 5 claim 20, where the data store is a computer database or repository.

32. A method of providing asset performance management according to claim 20, where the interface is an Internet website which is in communication with the data store.

33. A method of providing asset performance management according to claim 20, where the step of monitoring of the asset performance includes real time tracking of the asset.

34. A method of providing asset performance management according to claim 33, where an asset reader is attached to the asset to transmit data.

35. A method of providing asset performance management according to 15 claim 34, where information stored in the data store further includes the asset's geographical location, and the data transmitted by the asset reader Includes the coordinates of the assets' location and a unique identification code.

36. A method of providing asset performance management according to claim 35, where the transmitted data pertaining to the asset's geographical location is automatically updated in the data store.

37. A method of providing asset performance management according to claim 36, where a floor plan of an asset users' premises is linked to the data store to continually monitor the location of the asset.
